(19) United States
(12) Patent Application Publication
(10) Pub. No.: US 2010/0178475 A1
(43) Pub. Date: Jul. 15, 2010

(54) MULTIFUNCTIONAL PLASTIC SHEET AND MANUFACTURING METHOD THEREOF

(75) Inventor: Kyu-Ha Son, Gyeonggi-do (KR)

Correspondence Address: GRAY ROBINSON, P.A., P.O. Box 2328, FT. LAUDERDALE, FL, 33303-9998, US

(73) Assignee: INPA CO., LTD., Goyang-si, Gyeonggi-do (KR)

(21) Appl. No.: 12/440,291

(22) PCT Filed: Jan. 3, 2008
(86) PCT No.: PCT/KR2008/000037

§ 371 Date: Mar. 6, 2009

(30) Foreign Application Priority Data
Jan. 3, 2007 (KR) 10-2007-0000592

(51) Int. Cl. B32B 27/00; B32B 38/00; B32B 38/14; C09J 7/02; B05D 3/06; B32B 3/10; B32B 9/06; B32B 5/00

(52) U.S. Cl. 428/201; 156/280; 156/272.6; 156/277; 428/354; 428/345; 428/452; 428/336

(57) ABSTRACT

Provided is a multifunctional plastic sheet that can be used not only as a writing board but also as a screen, and a manufacturing method thereof. The multifunctional plastic sheet includes a multifunctional plastic sheet, which includes a first plastic film coated with acrylate resin or treated with corona discharge; a bead-including UV coating layer formed on an upper side of the first plastic film; a second plastic film laminated with a bottom side of the first plastic film; and a permanent or removable adhesive layer formed at a bottom side of the second plastic film.

### TECHNICAL FIELD

The present invention relates to a multifunctional plastic sheet that can be used as a screen as well as a writing board and a manufacturing method thereof; and, more particularly, to a multifunctional plastic sheet that has excellent durability, sense of writing, and erasability, allows the use of diverse writing pens, comes with mobility and portability for users' convenience.

### BACKGROUND ART

Generally, black boards with chalk or white boards with marker pens have been used in lecture rooms, offices and home for the purposes of noting, lecturing, explaining, playing games and so forth.

Blackboards are most widely used at school and include an initial form where a pigment is applied to a piece of a board and a blackboard using magnet or a blackboard formed of iron so that a chart or a material can be unfold and presented on the blackboard. Another widely used type of boards is a whiteboard that is formed by applying a synthetic resin onto an iron board and people use a water-erasable marker pen to write on the whiteboard.

Conventional boards, however, are generally manufactured by laminating a patterned coating sheet with the back side of Medium-Density Fibreboard (MDF) and laminating a white tissue paper with the upper side of the MDF. Thus, they are heavy, hard to be cut and set up. Also, since only chalk is usable for blackboards and maker pens are usable for whiteboards, the kinds of available pens for the boards are limited.

Nowadays, more and more people use a beam projector for presentations at meetings or conferences, and a screen is necessary for the use of a beam projector. However, blackboards or whiteboards do not provide a screen but it provides only a panel where people can write something thereon. Moreover, since whiteboard is lustrous on the surface, it may cause an eye vision problem when it is used as a screen. Therefore, it is troublesome and inconvenient to have both of a board for writing and a board for screen.

Therefore, there are demands for the development of a multifunctional board which can be used for both writing and screen purposes, which is so light that it is can be easily moved and carried, and which allows the use of diverse writing pens.

### DISCLOSURE

### Technical Problem

An embodiment of the present invention is directed to providing a multifunctional plastic sheet which is so light that it can be easily moved and used, which can be used for both writing and screen purposes, and which has an adhesive property to be easily set up, maintained and fixed, and a manufacturing method thereof.

### Technical Solution

The inventor(s) of the present invention earnestly studied to solve the above-mentioned problems and finally found a way to manufacture a highly durable multifunctional plastic sheet that can be used for both writing and screen purposes by coating a plastic film with acrylate resin or performing corona treatment onto a plastic film, and coating the plastic film with acrylate resin or corona again with ultraviolet (UV) coating solution including beads.

In accordance with an aspect of the present invention, there is provided a method for manufacturing multifunctional plastic sheet, which includes the steps of: coating an upper side of a first plastic film with acrylate resin or performing corona treatment onto the upper side of the first plastic film; coating the coated or treated upper side of the first plastic film with a bead-including ultraviolet (UV) coating solution; laminating a bottom side of the coated first plastic film with an upper side of a second plastic film; and forming a permanent or removable adhesive layer on a bottom side of the second plastic film of the laminated films.

In accordance with an aspect of the present invention, there is provided a multifunctional plastic sheet, which includes; a first plastic film coated with acrylate resin or treated with corona discharge; a bead-including UV coating layer formed on an upper side of the first plastic film; a second plastic film laminated with a bottom side of the first plastic film; and a permanent or removable adhesive layer formed at a bottom side of the second plastic film.

### ADVANTAGEOUS EFFECTS

The multifunctional plastic sheet of the present invention can be used not only as a writing board but also as a screen and it shows excellence in properties such as durability, sense of writing, and erasability. A variety of writing pens can be used on the multifunctional plastic sheet, and the sheet can be attached or detached according to a purpose or attached and fixed to be used conveniently. The multifunctional plastic sheet of the present invention provides users with excellent sense of writing and what is written on the multifunctional plastic sheet is erased easily. Since the multifunctional plastic sheet also has long durability and excellent UV-resistance and it can be moved conveniently, it is expected to draw attentions in related industries.

### BRIEF DESCRIPTION OF THE DRAWINGS

FIG. 1 illustrates a multifunctional plastic sheet manufactured by adhesively laminating a first plastic film with a second plastic film in accordance with an embodiment of the present invention.

FIG. 2 illustrates a multifunctional plastic sheet having a first plastic film with a second plastic film integrated in the form of a single layer in accordance with another embodiment of the present invention.

### BEST MODE FOR THE INVENTION

Hereinafter, the present invention will be described in detail.

In the present invention, a term ‘plastic film’ includes films manufactured using plastic resin such as polyethylene terephthalate, polyvinylchloride, polypropylene, polyethylene, polyester, and urethane, which are generally called plastic films by those skilled in the art to which the present invention pertains.

In the present invention, a first plastic film is a side for a writing purpose whereas a second plastic film is a layer for providing thickness and color. Each plastic film is selected to be appropriate for the purposes. Since the first plastic film is a side for writing, it is desirable to use a film with a low frictional coefficient, e.g., a polyester film, whose thickness ranges from about 20 μm to about 100 μm. Out of the thickness range, the first plastic film shall have such problems as degraded screening effect and elongation rate.

The second plastic film is formed of fabric. There is no specific requirement for the fabric and the fabric may be one selected from the group consisting of polyvinylchloride film, polypropylene film, polyethylene film, and urethane film. Also, a plastic film manufactured by adding pigment, dye, and/or coloring agent may be used as the second plastic film and the thickness of the second plastic film may range from about 100 μm to about 300 μm.

The first plastic film and the second plastic film used in the multifunctional plastic sheet of the present invention may be different from each other. According to an embodiment of the present invention, the first plastic film and the second plastic film may be integrated in the form of a single layer. When the first plastic film and the second plastic film may be integrated in the form of a single layer, it is desirable to use a film selected from the group consisting of polyvinylchloride film, polypropylene film, and polyester film to maintain an elongation rate and hardness and prevent the multifunctional plastic sheet from being cracked.

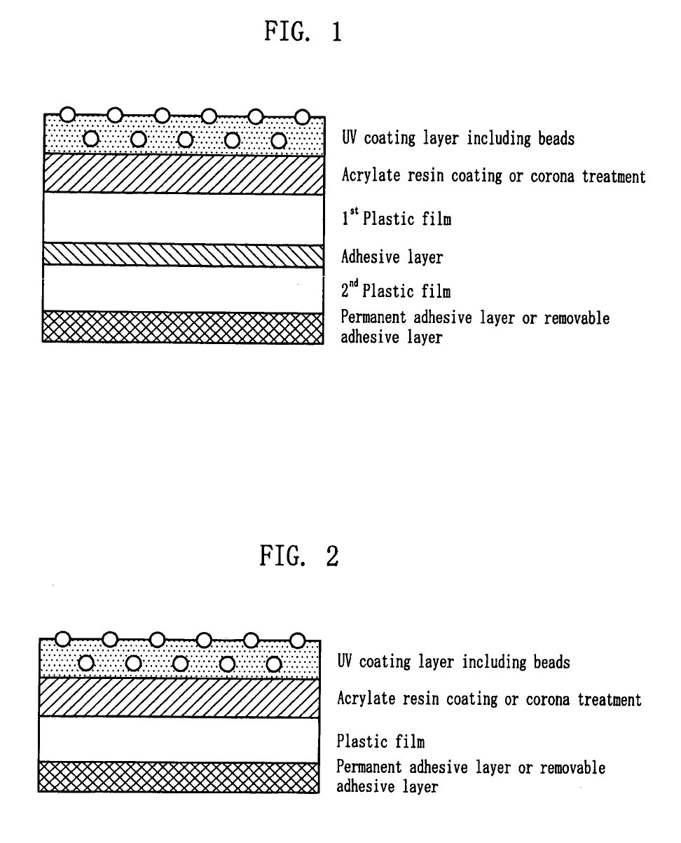

FIGS. 1 and 2 illustrate a multifunctional plastic sheet in accordance with specific embodiments of the present invention. FIG. 1 illustrates a multifunctional plastic sheet manufactured by adhesively laminating a first plastic film, and FIG. 2 illustrates a multifunctional plastic sheet having a first plastic film with a second plastic film integrated in the form of a single layer.

The multifunctional plastic sheet of the present invention is manufactured as follows. One side of a first plastic film is coated with acrylate resin or goes through corona treatment. The purpose of the acrylate resin coating or corona treatment is to maintain an adhesive force between the first plastic film and an ultraviolet (UV) coating layer to retain pencil hardness of over 3H under bad conditions of hardness and bending.

The acrylate resin coating is carried out by coating one side of the first plastic film with acrylate resin in a predetermined thickness, for example, in a thickness of about 0.3 μm to about 0.5 μm through a typical coating method.

The corona treatment is carried out by radiating discharged corona to a material to be treated, such as polyolefin film, paper or metal, to thereby functionalize the surface of the material. To be specific, a high-frequency and high-voltage power output is applied from a high-frequency power source to space between a discharge electrode and a processing roll to thereby generate corona discharge and the material is inputted to pass through the corona discharge space. The corona treatment is performed to enhance adhesiveness and relieve stain in a preliminary process of coating and printing.

According to an embodiment of the present invention, the corona treatment may be carried out to stably maintain properties by reinforcing adhesiveness between the first plastic film and the bead-including UV coating layer. The corona treatment may be carried out in a method known to those skilled in the art to which the present invention pertains, for example, performing corona discharge over 42 dyne/cm², but the present invention is not limited to it.

According to an embodiment of the present invention, either acrylate resin coating or corona treatment may be performed onto a plastic film in the above-described method or a film coated with acrylate resin or treated with corona discharge, which is available in the market, may be used as the first plastic film.

The side of the first plastic film treated in one of the above-described methods is coated with a UV coating solution including beads to thereby form a bead-including UV coating layer. The bead-including UV coating layer maximizes a dull effect in the coated side to thereby minimize a reflection rate when a screen beam is projected thereto, protect eye vision, enhance softness and maintain elongation rate so that no cracks occur, and maintain pencil hardness of over 3H, preferably, from about 3H to about 5H. Also, the effect of forming the surface dull and embossed can give users excellent sense of writing and erasability when the users use diverse writing pens. It also gives the board durability.

As for the beads, polymethyl methacrylate (PMMA) beads may be used because they are excellent as screen and have fine writing property, erasability and adhesiveness. The size of the beads may range from about 2 μm to about 10 μm. The UV coating solution may be one for hard coating which is available in the market, and about 5 to about 10 parts by weight beads are added to about 100 parts by weight UV coating solution. When the amount of beads in the UV coating solution is less than about 5 parts by weight, the function as screen and the sense of writing deteriorate. When it exceeds about 10 parts by weight, durability and hardness are weak.

The bead-including UV coating solution is agitated so that it is not precipitated, and it is applied to the above-treated side of the first plastic film in a thickness of about 3 μm to about 20 μm through a conventional coating method. When the bead-including UV coating solution is thinner than about 3 μm, the hardness and adhesiveness maintaining force are deteriorated. When the bead-including UV coating solution is thicker than about 20 μm, the hardness may be deteriorated and cracks may be caused.

Pattern may be printed at the back of the first plastic film which is treated as described above. When pattern is printed, the printed side is not exposed out of the surface. Therefore, the pattern or characters printed inside is not affected by repeated writing and erasion and the printed pattern or characters are kept. The pattern printing is performed through a typical plastic film printing method.

According to another embodiment, when the first plastic film and the second plastic film are integrated in the form of a single layer, pattern is printed on the upper side of the plastic film and a bead-including UV coating is formed on the plastic film.

A step of maturing the first plastic film with the bead-including UV coating layer may be additionally performed at a predetermined temperature for a predetermined time. The maturing stabilizes polymers and prevents curling in the course of laminating the two plastic films, and the temperature and time may be adjusted according to the kind of the used plastic film. Generally, the maturing is carried out for about 72 hours at temperature ranging from about 40° C. to about 90° C. When the temperature and time of the maturing are out of the ranges, adhesiveness maintaining force is not secured between the first plastic film and the second plastic film and thus the two plastic films may be separated.

The first film with the bead-including UV coating layer thereon is adhesively laminated with the second plastic film. In other words, an adhesive agent is applied to the upper side of the second plastic film to be adhesively limited with the other side of the first plastic film. There is no limit in the kinds of the adhesive agent as long as the adhesive agent is used for typical lamination of plastic films. For example, a polyester adhesive agent may be used.

According to another embodiment, corona treatment may be performed onto the upper side of the second plastic film before the bottom side of the first plastic film is laminated with the upper side of the second plastic film. The corona treatment can provide a preliminary treatment effect such as adhesiveness enhancement and stain alleviation. The corona treatment is performed in a generally known method.

The plastic sheet of the present invention may be attached and fixed to be used by forming a permanent adhesive layer or a removable adhesive layer on the bottom side of the laminated second plastic film, or the plastic sheet of the present invention may be attached detachably without any damage. Accordingly, a permanent adhesive agent or a removable adhesive agent is selected according to a purpose and used for the manufacturing of the plastic sheet. The kinds of the permanent adhesive agent and the removable adhesive agent are widely known to those skilled in the art and they are not limited to specific ones. For example, acrylic adhesive agents may be used to acquire cold-resistance, heat-resistance and removable property. Particularly, the plastic sheet of the present invention can be attached to or detached from diverse materials such as wallpaper, glass, refrigerator, and wood rock, without damage, because it can have the removable adhesive layer.

According to another embodiment of the present invention, corona treatment may be performed on the bottom side of the second plastic film before a permanent adhesive layer or a removable adhesive layer is formed on the bottom side of the second plastic film. The corona treatment is a preliminary step aiming to enhance adhesiveness and alleviate stain. The corona treatment is performed through a generally known method.

It is also possible to laminate the permanent adhesive layer or removable adhesive layer with a back layer for the purposes of packing, keeping and moving in the plastic sheet manufactured as described above. The back layer is formed by coating one side of a sheet of paper, which is an exfoliation layer, with a plastic film and then coating it again with silicon. The technique for forming the back layer is widely known to those skilled in the art of this invention.

The multifunctional plastic sheet, fabricated according to the present invention, has excellent properties and it can be used not only as a writing board but also as a screen. Since it can be rolled up and carried by a user, it is convenient to use the plastic sheet.

Hereinafter, the multifunctional plastic sheet of the present invention will be described in detail by taking the following examples. The following examples do not limit the scope of the present invention and proper modifications may be applied based on what is defined in the claims of this specification.

### Example 1

### Manufacturing of Plastic Sheet (1)

A side of polyester (PET) film (which is a product SS102 with a thickness of about 38 μm produced by Hwaseung Industries Company) was coated with acrylate resin (which is a product SH92 produced by SKC Company) in a thickness of about 0.5 μm. About 100 parts by weight UV coating solution (which is a product UC150H produced by UREI) was mixed with about 7 parts by weight polymethyl methacrylate (PMMA) bead powder (product MS-1000 produced by SOKEN Company) and left for about one hour to thereby prepare a bead-including UV coating solution. The coating solution was agitated not to be precipitated by using a pumping impeller, and the acrylate resin-coated side of PET film was coated with the coating solution in a thickness of about 20 μm. After the coating, the coated PET film was matured at about 90° C. for about 48 hours.

A polyester adhesive agent was applied to a side of PVC film (which is a product WH57A produced by HLCC Company) and the PVC film was laminated with the coated PET film by using a lamination device. The lamination of the PVC film and the PET film was matured at about 90° C. for about 72 hours.

An acrylic adhesive layer was formed on the other side of the laminated PVC film to thereby form a multifunctional plastic film. As for a removable adhesive agent, a product AP-14M of Cosmotec Company was used, and a product CMT-8700A was used as a permanent adhesive agent.

### Example 2

### Manufacturing of Plastic Sheet (2)

A multifunctional plastic sheet was manufactured in the same method as the Example 1, except that corona discharge treatment was performed over about 42 dyne/cm² instead of the acrylate resin coating.

### Example 3

### Manufacturing of Plastic Sheet (3)

A plastic film was formed of a PVC film and a PP film laminated with each other. The PVC film is a product WH57A produced by HLCC Company, and the PP film is a product GR80 produced by HLCC Company. A side of the plastic film was coated with acrylate resin (which is a product SH92 produced by SKC Company) in a thickness of about 0.3 μm. A product WH57A produced by HLCC Company was used as a PVC film and a product GR80 produced by HLCC Company was used. About 100 parts by weight UV coating solution (which is a product UC150H produced by UREI Company) was mixed with about 7 parts by weight polymethyl methacrylate (PMMA) bead powder (which is a product MS-1000 produced by SOKEN Company) and left for about one hour to thereby prepare a bead-including UV coating solution. The coating solution was agitated not to be precipitated by using a pumping impeller, and the acrylate resin-coated side of the plastic film was coated with the coating solution in a thickness of about 3 μm. After the coating, the coated plastic film was matured at about 90° C. for about 48 hours.

An acrylic adhesive layer was formed on the other side of the coated plastic film to thereby form a multifunctional plastic film. As for a removable adhesive agent, a product AP-14M of Cosmotec Company was used, and a product CMT-8700A was used as a permanent adhesive agent.

### Example 4

### Manufacturing of Plastic Sheet (4)

A multifunctional plastic sheet was manufactured in the same method as the Example 3, except that corona discharge treatment was performed over about 42 dyne/cm² instead of the acrylate resin coating.

### Experimental Example 1

The film characteristics of the multifunctional plastic sheet manufactured according to the Example 1 were as presented in the following Table 1.

TABLE 1

| | Test | | Test Result |
|---|---|---|---|
| Film | Adhesiveness (Cross Cut) | | fine |
| Characteristics | Luster (60°, %) | | 5 |
| | Solvent-resistance | | over 50 |
| | (MEK Rubbing Test) | | times |
| | UV-resistance | | 0.5 |
| | (UV Lamp, 22,000 | | mj/cm², ΔE) |
| | Chemical- | 5%-NaOH | fine |
| | resistance | 5%-CH₃COOH | fine |
| | Pencil Hardness (uni) | | over 3H |
| | Abrasion Test | Top test | −0.0044 g |
| | | CS-10, | |
| | | 500 g × 200 times | |

| | |
|---|---|
| Sense of Writing | 90/100 |
| Erasability | 95/100 |
| Afterimage | 90/100 |

The Table 1 shows that the multifunctional plastic sheet of the present invention was excellent in abrasion-resistance, chemical-resistance, UV-resistance, and solvent-resistance, and had long durability and pencil hardness of over 3H. Thus, it can be used as both writing board and screen. Furthermore, the multifunctional plastic sheet of the present invention showed superior characteristics to conventional whiteboards or blackboards in the respect of sense of writing, erasability and afterimage on a scale of 0 to 100, 0 lowest and 100 highest.

### Experimental Example 2

The multifunctional plastic sheet manufactured according to the Example 1 was compared with conventional blackboard and whiteboard and the result was as presented in the following Table 2.

TABLE 2

| | Pencil | | | Abrasion- | | |
|---|---|---|---|---|---|---|
| | Hard- | Sense of | Eras- | resis- | | |
| | ness | Writing | ability | tance | Luster | Available pens |
| Black- | HB | fine | regular | regular | lusterless | chalk |
| board | | | | | | |
| White- | 3H | fine | regular | fine | lustrous | marker pen |
| board | | | | | | |
| Example 1 | over 3H | fine | fine | fine | lusterless | Chalk, water paint, |
| | | | | | | marker pen, screen board |

The Table 2 shows that the plastic sheet of the present invention was excellent in sense of writing, erasability, abrasion-resistance and hardness, and diverse pens can be used for the plastic sheet. Furthermore, its lusterless characteristic allows the plastic sheet to be used as a screen.

What is claimed is:

1. A method for manufacturing multifunctional plastic sheet, comprising the steps of:
coating an upper side of a first plastic film with acrylate resin or performing corona treatment onto the upper side of the first plastic film;
coating the coated or treated upper side of the first plastic film with a bead-including ultraviolet (UV) coating solution;
laminating a bottom side of the coated first plastic film with an upper side of a second plastic film; and
forming a permanent or removable adhesive layer on a bottom side of the second plastic film of the laminated films.

2. The method of claim 1, further comprising the step of:
performing a corona treatment on the upper side of the second plastic film before the lamination.

3. The method of claim 1, further comprising the step of:
performing a corona treatment onto the bottom side of the laminated second plastic film before the permanent or removable adhesive layer is formed.

4. The method of claim 1, further comprising the step of:
printing a pattern on the bottom side of the first plastic film after the bead-including UV coating solution coating.

5. The method of claim 1, further comprising the step of:
coating a side of a sheet of paper to be used as an exfoliation layer with a plastic film, coating the coated side of the paper with silicon to thereby form a back layer, and laminating the back layer with the permanent or removable adhesive layer.

6. The method of claim 1, wherein the first plastic film is a polyester film.

7. The method of claim 1, wherein the second plastic film is one selected from the group consisting of polyvinylchloride, polyethylene film, polypropylene film, and urethane film.

8. The method of claim 1, wherein in the step of coating the coated or treated upper side of the first plastic film with a bead-including UV coating solution,
the upper side of the first plastic film is coated with the bead-including UV coating solution that is prepared by mixing about 100 parts by weight UV coating solution with about 5 to 10 parts by weight polymethyl methacrylate bead and leaving the mixture for about 0.5 to about 2 hours in a thickness ranging from about 3 μm to about 20 μm.

9. The method of claim 1, further comprising the step of:
maturing the first plastic film coated with the bead-including UV coating solution at about 40° C. to about 90° C. for about 48 to about 72 hours.

10. A multifunctional plastic sheet, comprising;
a first plastic film coated with acrylate resin or treated with corona discharge;
a bead-including UV coating layer formed on an upper side of the first plastic film;
a second plastic film laminated with a bottom side of the first plastic film; and
a permanent or removable adhesive layer formed at a bottom side of the second plastic film.

11. The multifunctional plastic sheet of claim 10, wherein the first plastic film is a polyester film.

12. The multifunctional plastic sheet of claim 10, wherein the second plastic film is one selected from the group consisting of polyvinylchloride, polyethylene film, polypropylene film, and urethane film.

13. The multifunctional plastic sheet of claim 10, wherein a pattern is printed on the bottom side of the first plastic film.

14. The multifunctional plastic sheet of claim 10, further comprising:
a back layer formed by coating a sheet of paper, which is used as an exfoliation layer, with a plastic film and silicon, and laminated with the permanent or removable adhesive layer.

15. The multifunctional plastic sheet of claim 10, wherein the bead-including UV coating solution is prepared by mixing about 100 parts by weight UV coating solution with about 5 to 10 parts by weight polymethyl methacrylate bead, leaving the mixture for about 0.5 to about 2 hours, and the prepared bead-including UV coating solution is applied in a thickness ranging from about 3 to about 20 μm.

16. The multifunctional plastic sheet of claim 10, wherein the first plastic film and the second plastic film is integrated in a form of a single layer.
